(19) United States
(12) Patent Application Publication
(10) Pub. No.: US 2018/0106680 A1
(43) Pub. Date: Apr. 19, 2018

(54) SHIELD PLATE AND MEASUREMENT APPARATUS

(71) Applicant: HAMAMATSU PHOTONICS K.K., Hamamatsu-shi, Shizuoka (JP)

(72) Inventor: Tomonori NAKAMURA, Hamamatsu-shi, Shizuoka (JP)

(73) Assignee: HAMAMATSU PHOTONICS K.K., Hamamatsu-shi, Shizuoka (JP)

(21) Appl. No.: 15/568,869

(22) PCT Filed: May 24, 2016
(86) PCT No.: PCT/JP2016/065319

§ 371 Date: Oct. 24, 2017

(30) Foreign Application Priority Data
May 27, 2015 (JP) 2015-107798

(51) Int. Cl. G01J 5/06; G01J 5/52; G01J 5/48; G01J 5/46; G01K 15/00

(52) U.S. Cl. CPC G01J 5/06; G01J 5/522; G01J 5/48; G01J 2005/0077; G01J 5/524; G01K 15/002; G01J 5/46

(57) ABSTRACT

A shield plate is a shield plate related to non-contact measurement of temperature of a semiconductor apparatus, and includes a base of which temperature is adjustable, in which the amount of thermal radiation of a blackbody surface located on one side of the base is larger than the amount of thermal radiation of a reflective surface located on a side opposite to the blackbody surface, and the blackbody surface is a blackbody surface that emits infrared rays.

### TECHNICAL FIELD

An aspect of the present invention relates to a shield plate and a measurement apparatus that are used for temperature measurement of a measurement target.

### BACKGROUND ART

Conventionally, a method described in Patent Literature 1, for example, is known as a method of measuring the surface temperature of a measurement target such as a semiconductor apparatus without contact. In the method described in Patent Literature 1, two portions having different emissivity that are measurement targets are irradiated with heat rays using an auxiliary heat source (surface blackbody), and heat rays in which heat rays generated by the measurement target and heat rays generated from the auxiliary heat source, which are reflected by the measurement target, are superimposed are detected by the infrared camera. By changing the temperature of the auxiliary heat source to detect the heat rays, it is possible to detect the surface temperature of the measurement target having an unknown emissivity without contact with high accuracy.

### CITATION LIST

### Patent Literature

[Patent Literature 1] Japanese Unexamined Patent Publication No. 2012-127678

### SUMMARY OF INVENTION

### Technical Problem

Here, in Patent Literature 1, heat rays with which a measurement target is irradiated from an auxiliary heat source and heat rays generated by the measurement target cannot be disposed coaxially. That is, there is a path of heat rays with which the measurement target is irradiated from an auxiliary heat source, separate from a path of heat rays generated by the measurement target. In such a configuration, in order to irradiate the measurement target with heat rays from the auxiliary heat source, it is necessary to provide an auxiliary heat source at a position different from a position on a path coupling the measurement target to the infrared camera. Accordingly, the method of Patent Literature 1 can be applied only to an apparatus that measures a measurement target having a certain size, and cannot be applied to an apparatus in which a micro-optical system such as a semiconductor apparatus inspection apparatus or the like is used.

An aspect of the present invention has been made in view of the above circumstances, and an object thereof is to measure the surface temperature of a measurement target without contact with high accuracy in an apparatus of a micro-optical system.

### Solution to Problem

A shield plate according to one aspect of the present invention is a shield plate that is used for non-contact measurement of a temperature of a measurement target, the shield plate including: a base of which a temperature is adjustable, wherein the amount of thermal radiation of a first surface located on one side of the base is larger than the amount of thermal radiation of a second surface located on a side opposite to the first surface, and the first surface is a blackbody surface that emits infrared rays.

In the shield plate, the amount of thermal radiation is different between the first surface and the second surface, the amount of thermal radiation of the first surface is larger than the amount of thermal radiation of the second surface, and the first surface is a blackbody surface that radiates infrared rays (heat rays). Therefore, in a micro-optical system semiconductor apparatus inspection apparatus or the like, when the first surface in a blackbody state is disposed to face the measurement target, the first surface serves as an auxiliary heat source, and the measurement target is irradiated with infrared rays from the first surface. Further, when the first surface serving as the auxiliary heat source is disposed to face the measurement target, the shield plate is disposed between the measurement target and an objective lens that guides infrared rays (light guiding optical system) in the above-described semiconductor apparatus inspection apparatus or the like. In this case, infrared rays in which infrared rays reflected by the measurement target according to the infrared rays emitted from the first surface are superimposed on the infrared rays generated by the measurement target itself can be detected by the imaging unit (infrared camera (infrared detector)). Further, since the base of which the temperature can be freely adjusted is included on the shield plate, it is possible to detect the superimposed infrared rays using the imaging unit while changing the temperature of the first surface that is an auxiliary heat source. Accordingly, it is possible to detect the surface temperature of the measurement target having an unknown emissivity without contact with high accuracy.

Here, in the configuration in which the shield plate is arranged between the measurement target and the imaging unit that captures the infrared rays, infrared rays with which the measurement target is irradiated from the first surface that is an auxiliary heat source and the infrared rays generated by the measurement target are coaxially arranged. Thus, the auxiliary heat source is not provided at a position different from on a path coupling the measurement target to the imaging unit. Therefore, in a micro-optical system of a semiconductor apparatus inspection apparatus or the like, it is possible to measure the surface temperature of the measurement target without contact. As described above, according to this shield plate, it is possible to measure the surface temperature of the measurement target without contact with high accuracy in an apparatus of a micro-optical system.

Further, the base may include a substrate layer, a first layer having the first surface as an outer surface, and a second layer having the second surface as an outer surface, the second layer being provided so that the substrate layer is sandwiched between the second layer and the first layer, and the amount of thermal radiation of the first layer may be larger than the amount of thermal radiation of the second layer. Thus, the base has a three-layer structure and the amount of thermal radiation of the first layer is larger than the amount of thermal radiation of the second layer, making it possible to easily cause the amount of thermal radiation of the first surface to be different from the amount of thermal radiation of the second surface.

Further, the base may include a substrate layer having the second surface as an outer surface, and a first layer having the first surface as an outer surface, the first layer being provided to overlap the substrate layer, and the amount of thermal radiation of the first layer may be larger than the amount of thermal radiation of the substrate layer. By causing the amount of thermal radiation of the first layer to be larger than that of the substrate layer, it is possible to easily cause the amount of thermal radiation of the first surface to be different from the amount of thermal radiation of the second surface. Further, since the base has a two-layer structure including the substrate layer and the first layer, it is easy for the shield plate to be manufactured.

Further, the base may include a substrate layer having the first surface as an outer surface, and a second layer having the second surface as an outer surface, the second layer being provided to be overlap the substrate layer, and the amount of thermal radiation of the second layer may be smaller than the amount of thermal radiation of the substrate layer. By causing the amount of thermal radiation of the second layer to be smaller than that of the substrate layer, it is possible to easily cause the amount of thermal radiation of the first surface to be different from the amount of thermal radiation of the second surface. Further, since the base has a two-layer structure including the substrate layer and the second layer, it is easy for the shield plate to be manufactured.

Further, the first surface is formed by a blackening treatment. By forming the first surface through a blackening treatment, it is easier for the shield plate to be manufactured, and it is possible to reduce the number of components.

Further, the base may include a substrate layer, a second layer having the second surface as an outer surface, and a heat insulating layer provided between the substrate layer and the second layer and preventing heat from being conducted from the substrate layer to the second layer. Since the heat insulating layer is provided between the substrate layer and the second layer, the temperature of the second surface can be stabilized.

Further, the second surface may be a reflective surface that reflects infrared rays. Thus, it is possible to reduce the amount of infrared rays radiated from the second surface. Further, the emissivity of the first surface may be higher than the emissivity of the second surface. Further, the temperature of the first surface may be higher than the temperature of the second surface. The amount of thermal radiation of a substance is proportional to a product of the emissivity of the substance and temperature of the substance. Therefore, by setting the emissivity of the first surface higher than the emissivity of the second surface or by setting the temperature of the first surface higher than the temperature of the second surface, it is possible to cause the amount of thermal radiation of the first surface to be larger than the amount of thermal radiation of the second surface.

A measurement apparatus according to an aspect of the present invention is a measurement apparatus that performs non-contact measurement of temperature of a measurement target, and is arranged to face a measurement target. The measurement apparatus includes a light guiding optical system that guides infrared rays from the measurement target; an imaging unit that is optically coupled to the light guiding optical system, images the infrared rays from the measurement target, and outputs thermal image data; the above-described shield plate arranged between the measurement target and the light guiding optical system; and a temperature control unit that controls temperature of the base of the shield plate.

In the measurement apparatus, the amount of thermal radiation is different between the first surface and the second surface of the shield plate, the amount of thermal radiation of the first surface is larger than the amount of thermal radiation of the second surface, and the first surface is a blackbody surface that radiates infrared rays. The first surface of the shield plate faces the measurement target. Thus, for example, a measurement signal is input from a signal input unit to the measurement target, the first surface serves as an auxiliary heat source in a state in which the measurement target is driven, the measurement target is irradiated with infrared rays from the first surface, and infrared rays in which infrared rays reflected by the measurement target are superimposed on infrared rays generated by the measurement target are imaged by the imaging unit. In the base of the shield plate, temperature adjustment is performed by the temperature control unit. Therefore, it is possible to image the superimposed infrared rays using the imaging unit while changing the temperature of the first surface that is an auxiliary heat source. Thus, it is possible to measure the surface temperature of the measurement target having an unknown emissivity without contact with high accuracy. Further, since the first surface of the shield plate faces the measurement target, the infrared rays with which the measurement target is irradiated from the first surface that is an auxiliary heat source and the heat rays generated by the measurement target are coaxially arranged. Thus, the auxiliary heat source is not provided at a position different from on a path coupling the measurement target to the imaging unit. Therefore, in the measurement apparatus of an aspect of the present invention that is an apparatus of a micro-optical system, it is possible to measure the surface temperature of the measurement target without contact with high accuracy.

Further, the measurement apparatus may further include: a calculation unit that calculates the temperature of the measurement target based on the thermal image data output from the imaging unit. Further, the temperature control unit may perform control so that the temperature of the base of the shield plate becomes at least first temperature and second temperature different from the first temperature, and the calculation unit may calculate the temperature of the measurement target based on the thermal image data at the first temperature and the thermal image data at the second temperature. Further, the imaging unit may include an infrared detector.

### Advantageous Effects of Invention

According to the shield plate and the measurement apparatus, it is possible to measure the surface temperature of the measurement target without contact with high accuracy in an apparatus of a micro-optical system.

### BRIEF DESCRIPTION OF DRAWINGS

FIG. 1 is a diagram schematically illustrating a configuration of a measurement apparatus according to a first embodiment of the present invention.

FIG. 2 is a plan view of a shield plate in the measurement apparatus of FIG. 1.

FIG. 3 is a cross-sectional view taken along line III-III of FIG. 2(a).

FIG. 4 is a bottom view of a shield plate according to a modification example.

FIG. 5 is a bottom view of a shield plate according to a modification example.

FIG. 6 is a bottom view of a shield plate according to a modification example.

FIG. 7 is a cross-sectional view of a shield plate according to a modification example.

FIG. 8 is a diagram schematically illustrating a configuration of a measurement apparatus according to a second embodiment of the present invention.

FIG. 9 is a plan view of the measurement apparatus of FIG. 8.

FIG. 10 is a cross-sectional view of a shield plate according to a modification example and a diagram schematically illustrating a configuration of a measurement apparatus using a shield plate according to a modification example.

### DESCRIPTION OF EMBODIMENTS

Hereinafter, embodiments of the present invention will be described in detail with reference to the drawings. In each figure, the same or corresponding portions are denoted with the same reference numerals, and repeated description thereof will be omitted.

### First Embodiment

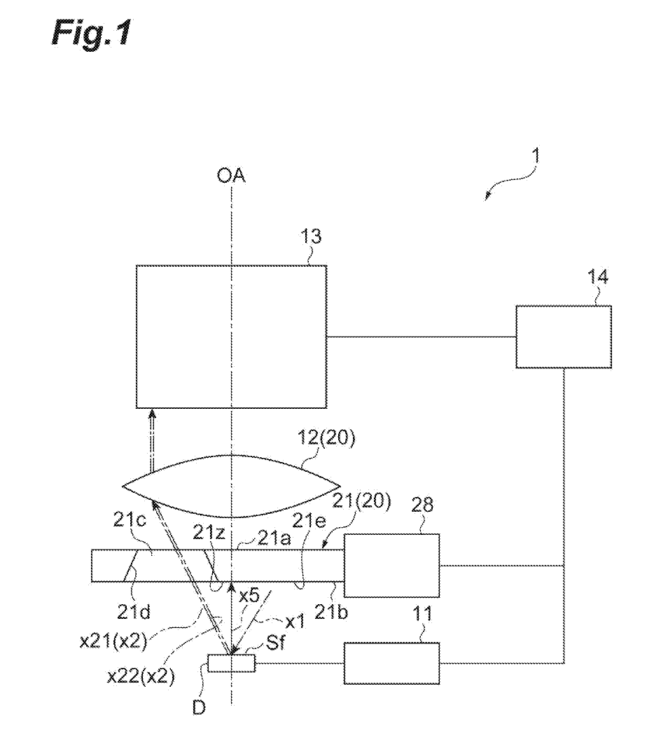

As illustrated in FIG. 1, a measurement apparatus 1 according to this embodiment is an apparatus (system) of a micro-optical system that measures temperature of a semiconductor apparatus D that is an apparatus under test (DUT) (a measurement target) without contact. More specifically, the measurement apparatus 1 measures the temperature of the semiconductor apparatus D without contact by performing heat observation in a state in which emissivity of the semiconductor apparatus D is unknown.

Examples of the semiconductor apparatus D include an integrated circuit having a PN junction such as a transistor (for example, a small scale integration (SSI), a medium scale integration (MSI), a large scale integration (LSI), a very large scale integration (VLSI), a ultra large scale integration (ULSI), a giga scale integration (GSI), a high current/high voltage MOS transistor or bipolar transistor, and a power semiconductor apparatus (power apparatus). Further, the semiconductor apparatus D is placed on a sample stage (Pot illustrated), for example. A measurement target is not limited to a semiconductor apparatus, and various apparatus, such as a solar cell module such as a solar cell panel, can be the measurement target.

The measurement apparatus 1 includes a tester unit 11 (signal input unit), an objective lens 12 (light guiding optical system), an infrared camera 13 (imaging unit or infrared detector), a computer 14 (calculation unit), a shield plate 20, and a temperature controller 28 (temperature control unit) in a functional configuration related to temperature measurement of the semiconductor apparatus D.

The tester unit 11 is electrically coupled to the semiconductor apparatus D via a cable and functions as a signal input unit that applies a measurement signal to the semiconductor apparatus D. The tester unit 11 is operated by a power supply (not illustrated), and repeatedly applies a signal for driving the semiconductor apparatus D, a clock signal, or the like as the measurement signal. The tester unit 11 may apply a modulated current signal or may apply a continuous wave (CW) current signal. The tester unit 11 is electrically coupled to the computer 14 via a cable, and applies a signal designated from the computer 14 to the semiconductor apparatus D. The tester unit 11 may not necessarily be electrically coupled to the computer 14. When the tester unit 11 is not electrically coupled to the computer 14, the tester unit 11 determines a signal as a single unit and applies the signal to the semiconductor apparatus D.

The shield plate 20 is a member used for non-contact measurement of the temperature of the semiconductor apparatus D. The shield plate 20 is arranged between the semiconductor apparatus D and the objective lens 12, and more specifically, the shield plate 20 is provided so that a central shield portion 21z thereof is located on an optical axis OA of the objective lens 12. The shield plate 20 includes a base 21 of which a temperature can be adjusted according to control of the temperature controller 28. A member having high thermal conductivity and characteristics of a blackbody or a reflective material may be used as the base 21. Further, the base 21 may have a structure in which a fluid flows therein, a heating wire, or the like. For example, the base 21 may have a heat pipe, a rubber heater, or the like therein.

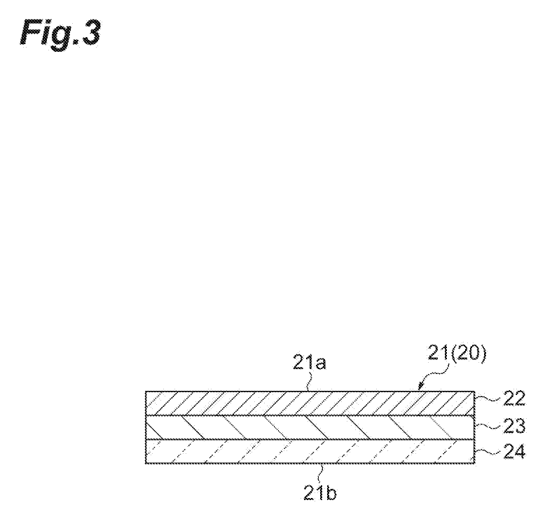

As illustrated in FIG. 3, the base 21 has a three-layer structure in which a substrate layer 23, a blackbody layer 24 (a first layer), and a reflective layer 22 (a second layer) are laminated. The substrate layer 23 conducts heat according to control of the temperature controller 28. The substrate layer 23 is provided to be sandwiched between the blackbody layer 24 and the reflective layer 22. Therefore, the substrate layer 23 and the blackbody layer 24, and the substrate layer 23 and the reflective layer 22 are thermally coupled. As the substrate layer 23, a member having high thermal conductivity capable of achieving a uniform temperature, such as a copper member (a copper plate or a copper layer), can be used. Further, the substrate layer 23 may have a structure in which a fluid flows therein, a heating wire, or the like. For example, the base 21 may include a heat pipe, a rubber heater, or the like therein.

The blackbody layer 24 is a first layer in which a surface (outer surface) opposite to a surface in contact with the substrate layer 23 is a blackbody surface 21b (a first surface). The blackbody surface 21b is a surface on one side in a stacking direction of the base 21. The blackbody surface 21b faces the semiconductor apparatus D. The blackbody layer 24 is subjected to, for example, Raydent (registered trademark) treatment or the like, and has a higher emissivity and a lower reflectance, that is, a larger amount of thermal radiation than the reflective layer 22. Accordingly, at least a portion of the blackbody surface 21b is in a blackbody state with respect to infrared rays. The amount of thermal radiation of the blackbody surface 21b in the blackbody state is larger than the amount of thermal radiation of a reflective surface 21a (which will be described in detail below) which is a surface on a side opposite to the blackbody surface 21b of the base 21, that is, a surface on the other side in a stacking direction of the base 21. A black ceramic coating film, for example, can be used as the blackbody layer 24. The blackbody refers to an object (complete blackbody) capable of completely absorbing electromagnetic waves incident from the outside over all wavelengths and radiating heat, but the blackbody state in this embodiment does not refer to a state in which a blackbody is a complete blackbody, and refers to a state in which the same degree of thermal radiation as a blackbody with respect to at least infrared rays can be realized. The state in which the same degree of thermal radiation as a blackbody can be realized refers to, for example, a state in which the emissivity is 90% or more.

The reflective layer 22 is a second layer in which a surface (outer surface) opposite to a surface in contact with the substrate layer 23 is a reflective surface 21a (a second surface) that reflects infrared rays. That is, the reflective layer 22 is provided so that the substrate layer 23 is sandwiched between the reflective layer 22 and the blackbody layer 24. The reflective surface 21a faces the objective lens 12. That is, the reflective surface 21a is a surface located on the opposite side to the blackbody surface 21b in the base 21. As the reflective layer 22, a member having high reflectance of the reflective surface 21a at a detection wavelength of the infrared camera 13, such as gold plating, can be used. The reflective surface 21a becomes a mirror surface due to high reflectance (for example, 90% or more). Therefore, the infrared camera 13 is in a Narcissus state (a state in which the infrared camera 13 views itself). Accordingly, it is possible to prevent a dark level of the infrared camera 13 from being changed according to a change in the temperature of the base 21 and to improve the SN.

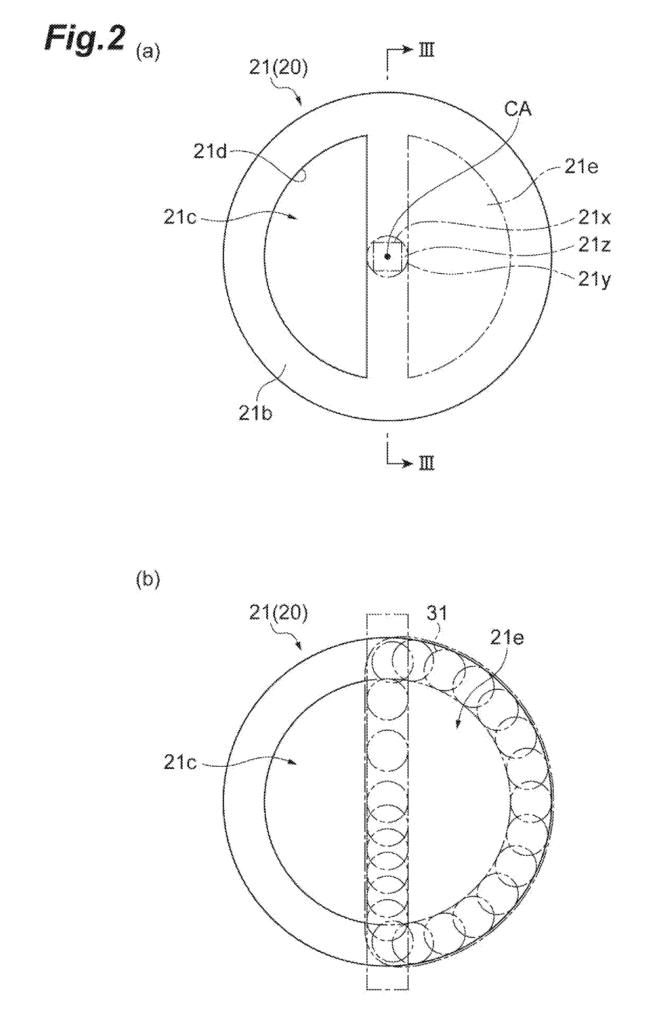

As illustrated in FIG. 2, the base 21 has the central shield portion 21z (first shield portion) in a blackbody state formed around a central axis CA of the shield plate 20 on the blackbody surface 21b. The central shield portion 21z is formed at least in a area of a circumscribed circle 21y of an effective visual field 21x of the infrared camera 13 around the central axis CA. A size of the effective visual field 21x of the infrared camera 13 is determined by the performance or an arrangement relationship between the objective lens 12 and the infrared camera 13. By forming the central shield portion 21z, a heat ray x5 (see FIG. 1) near the optical axis OA among the heat rays radiated from the semiconductor apparatus D to the infrared camera 13 is not transferred to the infrared camera 13.

Here, in a temperature deriving method in the computer 14 to be described below, the heat rays including the heat rays radiated from the semiconductor apparatus D and the heat rays reflected in the semiconductor apparatus D are detected by the infrared camera 13 and, therefore, the temperature is derived. The heat rays reflected by the semiconductor apparatus D are heat rays reflected by the semiconductor apparatus D according to the heat rays radiated from the blackbody surface 21b to the semiconductor apparatus D. If the central shield portion 21z is not provided and the area of the central axis CA in the base 21 has an open form, no blackbody is provided directly above the semiconductor apparatus D on the central axis CA. In this case, there are no heat rays on the central axis CA, which are heat rays reflected by the semiconductor apparatus D according to the heat rays radiated from the blackbody surface 21b to the semiconductor apparatus D as described above. Therefore, the heat rays passing through the central axis CA and detected by the infrared camera 13 are only the heat rays radiated from the semiconductor apparatus D, and there is a concern that the temperature may not be able to be appropriately measured using the above-described temperature deriving method. In this respect, by providing the central shield portion 21z, it is possible to prevent only the heat rays radiated from the semiconductor apparatus D from being detected by the infrared camera 13.

Further, the base 21 includes an opening 21c formed around the central shield portion 21z. More specifically, the opening 21c is formed adjacent to the circumscribed circle 21y in the blackbody surface 21b and in a semicircular shape when viewed from a bottom surface. Only one opening 21c is formed around the central shield portion 21z so that the opening 21c is one-fold rotationally symmetrical around the central shield portion 21z. The opening 21c is formed to penetrate the base 21 from the blackbody surface 21b to the reflective surface 21a (see FIG. 1). Further, the opening 21c is formed such that the opening shape gradually decreases from the blackbody surface 21b side toward the reflective surface 21a side. More specifically, an inner circumferential surface 21d of the opening 21c that defines a region of the opening 21c has an oblique structure approaching a center of the opening 21c from the blackbody surface 21b side to the reflective surface 21a side (See FIG. 1). The inner circumferential surface 21d is subjected to Raydent (registered trademark) treatment or the like and is in a blackbody state. The oblique structure of the inner circumferential surface 21d is determined in consideration of a viewing angle determined by the infrared camera 13 and the objective lens 12 so that the inner circumferential surface 21d cannot be observed from the infrared camera 13. Due to the inner circumferential surface 21d having such an oblique structure, only heat rays generated from the semiconductor apparatus D being reflected by the inner circumferential surface 21d and detected by the infrared camera 13 can be prevented.

Further, the base 21 has an opposite shield portion 21e (a second shield portion) in a blackbody state formed on the blackbody surface 21b to face the opening 21c with the central shield portion 21z sandwiched therebetween. More specifically, the opposite shield portion 21e is formed to include a region that faces the opening 21c around the central axis CA. A size (an area) of the opposite shield portion 21e may be smaller than a size (an area) of the opening 21c in the blackbody surface 21b. As illustrated in FIG. 2, a shape and a size of the opposite shield portion 21e may be substantially coincident with a shape and a size of the opening 21c in the blackbody surface 21b.

As illustrated in FIG. 1, the semiconductor apparatus D is irradiated with a heat ray x1 from the opposite shield portion 21e that is in a blackbody state. In the semiconductor apparatus D, a heat ray x21 is reflected according to the heat ray x1. The heat ray x21 reaches the opening 21c that faces the opposite shield portion 21e. Further, a heat ray x22 generated in the semiconductor apparatus D reaches the opening 21c. That is, heat rays x2 including the heat ray x21 reflected by the semiconductor apparatus D and the heat ray x22 generated by the semiconductor apparatus D reach the opening 21.c. The heat rays x2 pass through the opening 21c and are detected by the infrared camera 13 via the objective lens 12.

Here, almost all heat rays detected by the infrared camera 13 may be the heat rays x2 in order to ensure accuracy of temperature derivation in the computer 14. That is, the heat rays reflected by the semiconductor apparatus D, which are detected by the infrared camera 13, may be the heat ray x21 reflected by the semiconductor apparatus D according to the heat rays with which the semiconductor apparatus D is irradiated from the opposite shield portion 21e which is a surface in a blackbody state. When the effective visual field 21x of the infrared camera 13 is not considered, that is, when a size of the effective visual field 21x of the infrared camera 13 is assumed to be 0, all the heat rays reflected by the semiconductor apparatus D, which are detected by the infrared camera 13, can be the heat ray x21 by providing the above-described opposite shield portion 21e. However, in reality, the infrared camera 13 detects heat rays reflected by the semiconductor apparatus D other than the heat ray x21 according to the size of the effective visual field 21x of the infrared camera 13. Specifically, the infrared camera 13 detects the heat rays reflected by the semiconductor apparatus D according to the heat rays with which the semiconductor apparatus D is irradiated from a region (hereinafter referred to as a peripheral region) between an outer edge of a region of the opposite shield portion 21e and a position further outside by a diameter of the circumscribed circle 21y of the effective visual field 21x from the outer edge. In order to cause the heat ray to be the same as the above-described heat ray x21, it is necessary to set the peripheral region to be in the same blackbody state as the opposite shield portion 21e. Therefore, in the above-described peripheral region, a peripheral shield portion 31 that is in a blackbody state like the opposite shield portion 21e is provided to surround the outer edge of the opposite shield portion 21e. The peripheral shield portion 31 is provided in a region defined according to the effective visual field of the infrared camera 13. More specifically, the peripheral shield portion 31 is provided in a region defined by a trajectory along which the circumscribed circle 21y of the effective visual field 21x of the infrared camera 13 is rotated around the opposite shield portion 21e.

Referring back to FIG. 1, the temperature controller 28 is a temperature control unit that controls the temperature of the shield plate 20. The temperature controller 28 is, for example, a heater or a cooler that is thermally coupled to the shield plate 20 and controls the temperature of the shield plate 20 by conducting heat to the shield plate 20. The temperature controller 28 controls the temperature of the shield plate 20 according to a setting from the computer 14. For example, the temperature controller 28 may control the temperature of the shield plate 20 by conducting heat to the shield plate 20 (the base 21) through a fluid, a heating wire, or the like.

The objective lens 12 is a light guiding optical system that guides the heat ray x2 passing through the opening 21c of the shield plate 20 to the infrared camera 13. The objective lens 12 is provided so that an optical axis thereof is coincident with the optical axis OA, and is arranged to face the semiconductor apparatus D.

The infrared camera 13 is an infrared detector (imaging unit) that images the heat ray x2 emitted from the semiconductor apparatus D driven according to the input of the measurement signal via the optically coupled objective lens 12. The infrared camera 13 includes a light reception surface in which a plurality of pixels that convert infrared rays into an electric signal are two-dimensionally arranged. The infrared camera 13 generates an infrared image (thermal image data) by imaging the heat rays, and outputs the infrared image to the computer 14. A two-dimensional infrared detector such as an InSb camera, for example, is used as the infrared camera 13. The infrared detector is not limited to a two-dimensional infrared detector such as the infrared camera 13, and a one-dimensional infrared detector such as a bolometer, or a point infrared detector may be used. Further, electromagnetic waves (light) having a wavelength of 0.7 μm to 1000 μm are generally referred to as infrared ray. Further, electromagnetic waves (light) in a region from mid-infrared rays having a wavelength of 2 μm to 1000 μm to far-infrared rays are referred to as heat rays, but there is no particular distinction in this embodiment, and heat rays refer to electromagnetic waves having a wavelength of 0.7 μm to 1000 μm, similar to infrared rays.

The computer 14 is electrically coupled to the infrared camera 13. The computer 14 derives the temperature of the semiconductor apparatus D based on the infrared image generated by the infrared camera 13. The computer 14 includes a processor that executes a function of deriving the temperature of the semiconductor apparatus D. Hereinafter, a derivation principle of temperature derivation based on the infrared image will be described.

In the semiconductor apparatus D, it is assumed that an area 1 which is an area with a constant emissivity and an area 2 which is an area with a constant emissivity lower than the emissivity of the area 1 are adjacent to each other. If the emissivity and reflectance of the respective areas are ρ1, ε1 and ρ2, ε2, Equations (1) and (2) below are satisfied due to Kirchhoffs law. Hereinafter, the area 1 with emissivity of ρ₁ may be referred to as a high emissivity portion, and the area 2 with emissivity of ρ₂ may be referred to as a low emissivity portion.

[Math. 1]

ρ₁+ε=1 (1)

[Math. 2]

ρ₂+ε₂=1 (2)

Here, if a thermal radiation luminance (the amount of thermal radiation) of the shield plate 20 is L_{low}, the radiation detected by the infrared camera 13 for the high emissivity portion is S_{1low}, radiation detected by the infrared camera 13 for the low emissivity portion is S_{2low}, and the thermal radiation luminance of the blackbody of temperature T is L(T), Equations (3) and (4) below are satisfied. S_{1low}, can be referred to as the thermal radiation luminance in the high emissivity portion, and S_{2low} can be referred to as the thermal radiation luminance in the low emissivity portion. That is, Equation (3) below shows that, when the thermal radiation luminance of the shield plate 20 is L_{low}, heat rays having the thermal radiation luminance of S_{1low} in which heat rays generated by semiconductor apparatus D, which are radiated from the high emissivity portion of the semiconductor apparatus D and the heat rays reflected by the semiconductor apparatus D are superimposed are detected by the infrared camera 13. Further, Equation (4) below shows that, when the thermal radiation luminance of the shield plate 20 is L_{low}, heat rays having the thermal radiation luminance of S_{2low} in which heat rays generated by semiconductor apparatus D, which are radiated from the low emissivity portion of the semiconductor apparatus D and the heat rays reflected by the semiconductor apparatus D are superimposed are detected by the infrared camera 13.

[Math. 3]

S_{1low}=ε₁L(T)+ρ₁L_{low}=(1−ρ₁)L(T)+ρ₁L_{low} (3)

[Math. 4]

S_{1low}=ε₁L(T)+ρ₁L_{low}=(1−ρ₁)L(T)+ρ₁L_{low} (3)

Similarly, when the thermal radiation luminance of the shield plate 20 is L_{high} and if the radiation detected by the infrared camera 13 with respect to the high emissivity portion is S_{1High}, the radiation detected by the infrared camera 13 with respect to the low emissivity portion is S_{2High}, and the thermal radiation luminance of the blackbody state at a temperature T of the semiconductor apparatus D is L(T), Equations (5) and (6) below are satisfied.

$$\begin{matrix}[ Math . 5 ] & \\ \begin{matrix}{S}_{1 high} = {ɛ}_{1} L ( T ) + {ρ}_{1} {L}_{high} \\ = ( 1 - {ρ}_{1} ) L ( T ) + {ρ}_{1} {L}_{high} \\ = L ( T ) + {ρ}_{1} ( {L}_{high} - L ( T ) )\end{matrix} & ( 5 ) \\ [ Math . 6 ] & \\ \begin{matrix}{S}_{2 high} = {ɛ}_{2} L ( T ) + {ρ}_{2} {L}_{high} \\ = ( 1 - {ρ}_{2} ) L ( T ) + {ρ}_{2} {L}_{high} \\ = L ( T ) + {ρ}_{2} ( {L}_{high} - L ( T ) )\end{matrix} & ( 6 )\end{matrix}$$

A ratio R of reflectance of the high emissivity portion and reflectance of the low emissivity portion is expressed by Equation (7) below from Equations (3) to (6) above.

[Math. 7]

R=ρ₁/ρ₂(S_{1high}−S_{1low})/(S_{2high}−S_{2low}) (7).

Equation (8) below is derived from Equation (3), (4), and (7) described above.

[Math. 8]

R=(S_{1high}−L(T))/(S_{2high}−L(T)) (8)

Similarly, Equation (9) below is described from Equation (5), (6), and (7) described above.

[Math. 9]

R=(S_{1low}−L(T))/(S_{2low}−L(T)) (9)

If Equation (8) described above is modified,

[Math. 10]

L(T)=(S_{1high}−RS_{2high})/(1−R) (10)

since the thermal radiation luminance L(T) is obtained at a temperature T of the semiconductor apparatus D that is a measurement target from Equation (10), temperature of the semiconductor apparatus D can be derived from the thermal radiation luminance.

Next, a procedure of measuring the temperature of the semiconductor apparatus D using the shield plate 20 will be described.

First, the semiconductor apparatus D is placed on a sample stage (not illustrated) of the measurement apparatus 1. The tester unit 11 is electrically coupled to the semiconductor apparatus D, and a measurement signal such as a signal for driving the semiconductor apparatus D and a clock signal is input from the tester unit 11.

Subsequently, the temperature of the shield plate 20 is controlled by the temperature controller 28 such that it becomes a temperature at which the thermal radiation luminance of the blackbody surface 21b of the shield plate 20 and, more specifically, the opposite shield portion 21e is L_{low}. In this case, the semiconductor apparatus D is irradiated with heat rays of which the thermal radiation luminance is L_{low} from the shield plate 20.

Heat rays including heat rays generated by the semiconductor apparatus D and heat rays reflected by the semiconductor apparatus D according to the heat rays from the shield plate 20 pass through the opening 21c and the objective lens 12 of the shield plate 20, and are detected by the infrared camera 13. The infrared camera 13 images the heat rays and generates the infrared image. The infrared image includes radiations of two areas with different emissivity, that is, the high emissivity portion and the low emissivity portion. The computer 14 identifies radiation S_{1low} of the high emissivity portion and radiation S_{2low} of the low emissivity portion from the infrared image.

Subsequently, the temperature of the shield plate 20 is controlled by the temperature controller 28 to be temperature at which the thermal radiation luminance of the blackbody surface 21b of the shield plate 20 and, more specifically, the opposite shield portion 21e is L_{high}. In this case, the semiconductor apparatus D is irradiated with heat rays of which the thermal radiation luminance is L_{high} from the shield plate 20.

Heat rays including heat rays generated by the semiconductor apparatus D and heat rays reflected by the semiconductor apparatus D according to the heat rays from the shield plate 20 pass through the opening 21c and the objective lens 12 of the shield plate 20, and are detected by the infrared camera 13. The infrared camera 13 images the heat rays and generates the infrared image. The infrared image includes radiations of two areas with different emissivity, that is, the high emissivity portion and the low emissivity portion. The computer 14 identifies radiation S_{1high} of the high emissivity portion and radiation S_{2high} of the low emissivity portion from the infrared image.

Finally, the temperature of the semiconductor apparatus D is derived by the computer 14 from the radiation S_{1low} of the high emissivity portion and the radiation S_{2low} of the low emissivity portion based on the heat rays with the thermal radiation luminance of L_{low} and the radiation S_{1high} of the high emissivity portion and the radiation S_{2high} of the low emissivity portion based on the heat rays with the thermal radiation luminance of L_{high}.

The procedure of measuring the temperature of the semiconductor apparatus D has been described above, but the temperature measurement using an aspect of the present invention is not limited to the above procedure. For example, the temperature of the shield plate 20 may be changed by the temperature controller 28 to a temperature at which the thermal radiation luminance is changed from L_{low} from L_{high}, and another shield plate different from the shield plate 20 may be provided and the shield plate 20 may be replaced with the other shield plate. In this case, for example, by setting the thermal radiation luminance of the shield plate 20 to L_{low} and the thermal radiation luminance of the other shield plate to L_{high}, it is possible to change the amount of thermal radiation with which the semiconductor apparatus D is irradiated. Further, zero point correction of the infrared camera 13 may be performed by arranging a sample coated with a metal (for example, gold or aluminum) having a very high emissivity as a measurement target to face the objective lens 12 in a state in which a shield plate 20 is not arranged, and detecting a dark state in which there are no heat rays emitted by the sample using the infrared camera 13 before the above-described procedure is performed.

Next, an operation and effects of the shield plate 20, and the measurement apparatus 1 including the shield plate 20 will be described.

In the shield plate 20, the amount of thermal radiation is different between the blackbody surface 21b and the reflective surface 21a, the amount of thermal radiation of the blackbody surface 21b is larger than the amount of thermal radiation of the reflective surface 21a, and the blackbody surface 21b is in a blackbody state with respect to infrared rays. Therefore, in a micro-optical system of the measurement apparatus 1 or the like, when the blackbody surface 21b that is in a blackbody state is arranged to face the semiconductor apparatus D, the blackbody surface 21b serves as an auxiliary heat source, and the semiconductor apparatus D is irradiated with heat rays from the blackbody surface 21b. Further, when the blackbody surface 21b serving as the auxiliary heat source is arranged to face the semiconductor apparatus D, the shield plate 20 is arranged between the semiconductor apparatus D and the infrared camera 13 that captures the heat rays in the measurement apparatus 1 or the like. In this case, heat rays in which heat rays reflected by the semiconductor apparatus D according to the heat rays emitted from the blackbody surface 21b are superimposed on the heat rays generated by the semiconductor apparatus D can be detected by the infrared camera 13. Further, since the base 21 of which the temperature can be freely adjusted is included on the blackbody surface 21b, it is possible to detect the superimposed heat rays using the infrared camera 13 while changing the temperature of the blackbody surface 21b that is an auxiliary heat source. Accordingly, it is possible to measure surface temperature of the semiconductor apparatus D having an unknown emissivity without contact with high accuracy using Equation (10) described above.

Here, in the configuration in which the shield plate 20 is arranged between the semiconductor apparatus D and the infrared camera 13 that captures the heat rays, the heat rays with which the semiconductor apparatus D is irradiated from the blackbody surface 21b that is an auxiliary heat source and the heat rays generated by the semiconductor apparatus D are coaxially arranged. Thus, the auxiliary heat source is not provided at a position different from on a path coupling the measurement target to the infrared camera, and in a micro-optical system of the measurement apparatus 1 or the like, it is possible to measure the surface temperature of the measurement target without contact. As described above, according to this shield plate 20, it is possible to measure the surface temperature of the measurement target without contact with high accuracy in an apparatus of a micro-optical system.

Further, the emissivity of the blackbody surface 21b is higher than the emissivity of the reflective surface 21a. Accordingly, it is possible to cause the amount of thermal radiation of the blackbody surface 21b to be larger than the amount of thermal radiation of the reflective surface 21a. Further, the reflective surface 21a having low emissivity has high reflectance. Therefore, in the measurement apparatus 1 described above, a lens of the infrared camera 13 facing the reflective surface 21a enters a Narcissus state (a state in which the lens views itself). Thus, it is possible to prevent a noise component other than the heat rays from the semiconductor apparatus D from being captured by the infrared camera 13, and to measure the surface temperature of the semiconductor apparatus D with higher accuracy. Further, the temperature of the blackbody surface 21b is higher than the temperature of the reflective surface 21a. Thus, it is possible to cause the amount of thermal radiation of the blackbody surface 21b to be larger than the amount of thermal radiation of the reflective surface 21a.

Further, the base 21 includes the substrate layer 23, the blackbody layer 24 having the blackbody surface 21b as an outer surface, and the reflective layer 22 having the reflective surface 21a as an outer surface, which is provided so that the substrate layer 23 is sandwiched between the reflective layer 22 and the blackbody layer 24, and the amount of thermal radiation of the blackbody layer 24 is larger than the amount of thermal radiation of the reflective layer 22. Thus, the base 21 has a three-layer structure and the amount of thermal radiation of the blackbody layer 24 is larger than the amount of thermal radiation of the reflective layer 22, making it possible to easily cause the amount of thermal radiation of the blackbody surface 21b to be different form the amount of thermal radiation of the reflective surface 21a.

Further, the measurement apparatus 1 is a measurement apparatus that performs non-contact measurement of the temperature of the semiconductor apparatus D, and includes a tester unit 11 that inputs a measurement signal to the semiconductor apparatus D, an infrared camera 13 that images heat rays from the semiconductor apparatus D according to the input of the measurement signal, a shield plate 20 arranged between the semiconductor apparatus D and the infrared camera 13, and a temperature controller 28 that freely adjustably controls temperature of the shield plate 20. In the measurement apparatus 1, the amount of thermal radiation is different between the blackbody surface 21b and the reflective surface 21a of the shield plate 20, the amount of thermal radiation of the blackbody surface 21b is larger than the amount of thermal radiation of the reflective surface 21a, and the blackbody surface 21b is in a blackbody state with respect to infrared rays. The blackbody surface 21b of the shield plate 20 faces the semiconductor apparatus D. Thus, for example, the measurement signal is input from the tester unit 11 to the semiconductor apparatus D, the blackbody surface 21b serves as an auxiliary heat source in a state in which the semiconductor apparatus D is driven, the semiconductor apparatus D is irradiated with heat rays from the blackbody surface 21b, and heat rays in which heat rays reflected by the semiconductor apparatus D are superimposed on heat rays generated by the semiconductor apparatus D are imaged by the infrared camera 13. In the base 21 of the shield plate 20, temperature adjustment is performed by the temperature controller 28. Therefore, it is possible to image the superimposed heat rays using the infrared camera 13 while changing the temperature of the blackbody surface 21b that is an auxiliary heat source. Thus, it is possible to measure surface temperature of the semiconductor apparatus D having an unknown emissivity without contact with high accuracy. Further, since the blackbody surface 21b of the shield plate 20 faces the semiconductor apparatus D, the heat rays with which the semiconductor apparatus D is irradiated from the blackbody surface 21b that is an auxiliary heat source and the heat rays generated by the semiconductor apparatus D are coaxially arranged. Thus, the auxiliary heat source is not provided at a position different from on a path coupling the measurement target to the imaging unit, and in the measurement apparatus 1 that is an apparatus of a micro-optical system, it is possible to measure the surface temperature of the semiconductor apparatus D without contact with high accuracy.

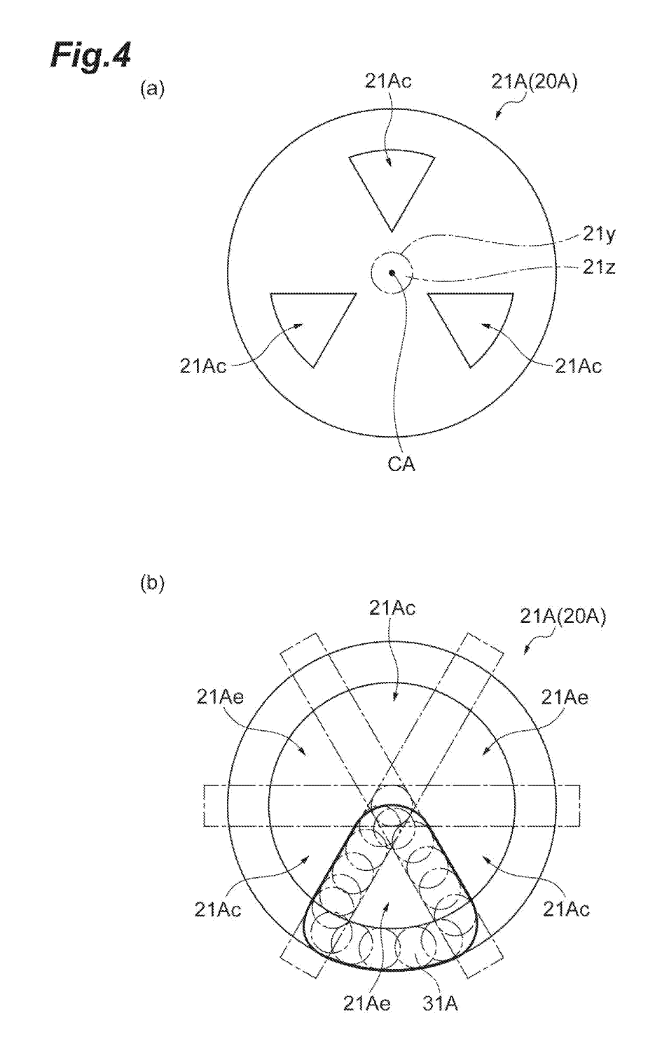

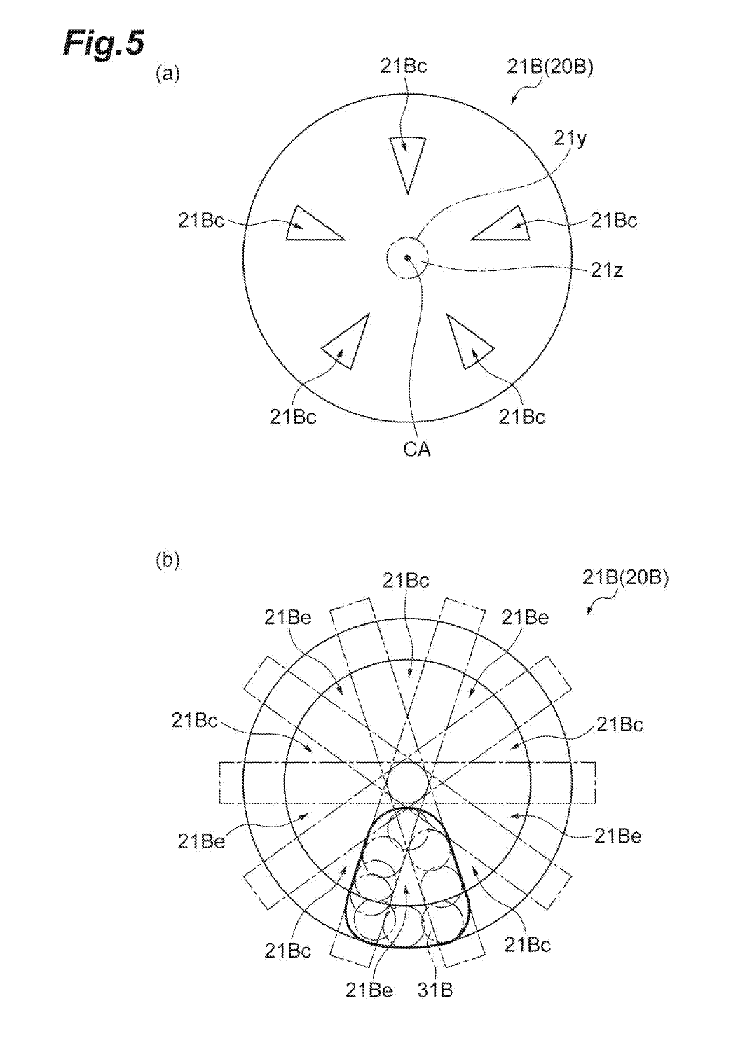

The first embodiment of the present invention has been described, but an aspect of the present invention is not limited to the first embodiment. For example, the case in which one opening 21c is formed in the shield plate 20 to be one-fold rotationally symmetrical around the central shield portion 21z has been described, but the present invention is not limited thereto and the opening may be formed around the central shield portion 21z to be odd-number-fold rotationally symmetrical around the central shield portion 21z. By providing the opening to be odd-number-fold rotationally symmetrical, it is possible to achieve a shape in which the opening reliably faces the facing shield portion. Further, by forming the opening in a rotationally symmetrical manner, it is possible to improve thermal conductivity of the shield plate and to improve temperature uniformity of the shield plate. Specifically, an example in which the opening is provided to be odd-number-fold rotationally symmetrical will be described with reference to FIGS. 4 and 5.

In a base 21A of a shield plate 20A illustrated in FIG. 4, openings 21Ac are formed around a central shield portion 21z so that the openings 21Ac are three-fold rotationally symmetrical around the central shield portion 21z. The opening 21Ac has a fan shape, and the three openings 21Ac are formed at equal intervals around the central shield portion 21z. Further, opposite shield portions 21Ae in a blackbody state are provided to face the openings 21Ac around the central axis CA. A shape and a size of the facing shield portion 21Ae is substantially coincident with a shape and a size of the opening 21Ac on a blackbody surface. Further, a peripheral shield portion 31A that is in a blackbody state like the opposite shield portion 21Ae is provided to surround the outer edge of the opposite shield portion 21Ae in a peripheral region that is a region between an outer edge of a region of the opposite shield portion 21Ae and a position on the outer side by a diameter of the circumscribed circle 21y of the effective visual field 21x from the outer edge.

In a base 21B of a shield plate 20B illustrated in FIG. 5, openings 21Bc are formed around a central shield portion 21z so that the openings 21Bc are five-fold rotationally symmetrical around a central shield portion 21z. The opening 21Bc has a fan shape, and five opening 21Bc are formed at equal intervals around the central shield portion 21z. Further, opposite shield portions 21Be in a blackbody state are provided to face the openings 21Bc around the central axis CA. A shape and a size of the facing shield portion 21Be is substantially coincident with a shape and a size of the opening 21Bc on a blackbody surface. Further, a peripheral shield portion 31B that is in a blackbody state like the opposite shield portion 21Be is provided to surround the outer edge of the opposite shield portion 21Be in a peripheral region that is a region between an outer edge of a region of the opposite shield portion 21Be and a position on the outer side by a diameter of the circumscribed circle 21y of the effective visual field 21x from the outer edge.

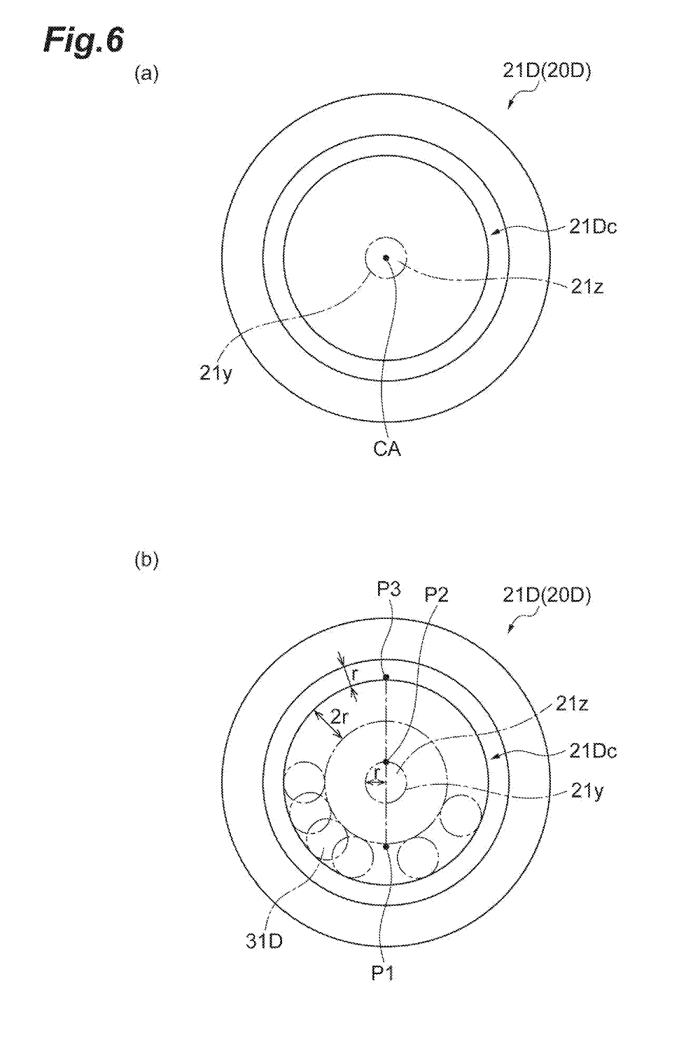

Further, as in a base 21D of a shield plate 20D illustrated in FIG. 6, an opening 21Dc may be formed in an annular shape around an opposite shield portion 31D (a second shield portion). In the base 21D, a central shield portion 21z in a blackbody state is formed to cover a central axis CA. The central shield portion 21z is formed in an area of a circumscribed circle 21y of an effective visual field 21x of an infrared camera 13 centered on the central axis CA. Further, if a radius of the circumscribed circle 21y is r, the opening 21Dc is formed from a position of 5r to a position of 6r from a center of the circumscribed circle 21y. That is, a width of the opening 21Dc having an annular shape is r. Further, the opposite shield portion 31D in the blackbody state is provided in a region between an inner edge of the opening 21Dc and a position further inside by a diameter (2r) of the circumscribed circle 21y from the inner edge. The opposite shield portion 31D serves as a second shield portion. That is, the opposite shield portion 31D is formed on a blackbody surface to face the opening 21Dc around a region on the opening 21Dc side from a center of the central shield portion 21z. For example, a shield point P1 that is one point of the opposite shield portion 31D faces an opening point P3 of the opening 21Dc around a center point P2 that is a point on the opposite opening 21Dc side relative to the center of the central shield portion 21z in the central shield portion 21z. Although not illustrated in FIG. 6, it is not necessary for an inner side of the opening 21Dc to be actually supported or for heat to be conducted, and therefore, at least one portion of the opening 21Dc can be physically coupled to an inner edge of the opening 21Dc and an outer edge of the opening 21Dc.

For example, when there are a portion in which the opening is formed and a portion in which the opening is not formed in a rotation direction around the central axis CA of the shield plate 20D, only a biased portion of a lens between an infrared camera and a measurement target is used, and an image flow in an image based on heat rays detected by an infrared camera may be a problem. When image flow is a problem, heat rays may be detected by the infrared camera while appropriately rotating the shield plate around the central axis CA, for example. By doing so, the temperature can be measured while preventing only a portion of the lens from being used. For example, if the shield plate is a one-fold rotationally symmetrical shield plate 20 illustrated in FIG. 2, heat rays are detected a plurality of times by the infrared camera while rotating the shield plate 20 at least once (rotating the shield plate 20 by 360°), and images based on a plurality of heat rays are integrated to reduce image flow (if the shield plate is a three-fold rotationally symmetrical shield plate 20A illustrated in FIG. 4, the shield plate 20A is rotated by at least ⅓ (rotated by 120°), and if the shield plate is a five-fold rotationally symmetrical shield plate 20B illustrated in FIG. 5, the shield plate 20B is rotated by at least ⅕ (rotated by 72°). In the shield plate 20D in which the opening 21Dc is annularly formed, heat rays passing through the opening 21Dc having an annular shape are detected by the infrared camera, and therefore, not only a portion of the lens between the infrared camera and the measurement target is used. Accordingly, it is difficult for the above-described image flow to occur and measurement can be performed without performing rotation of the shield plate or the like.

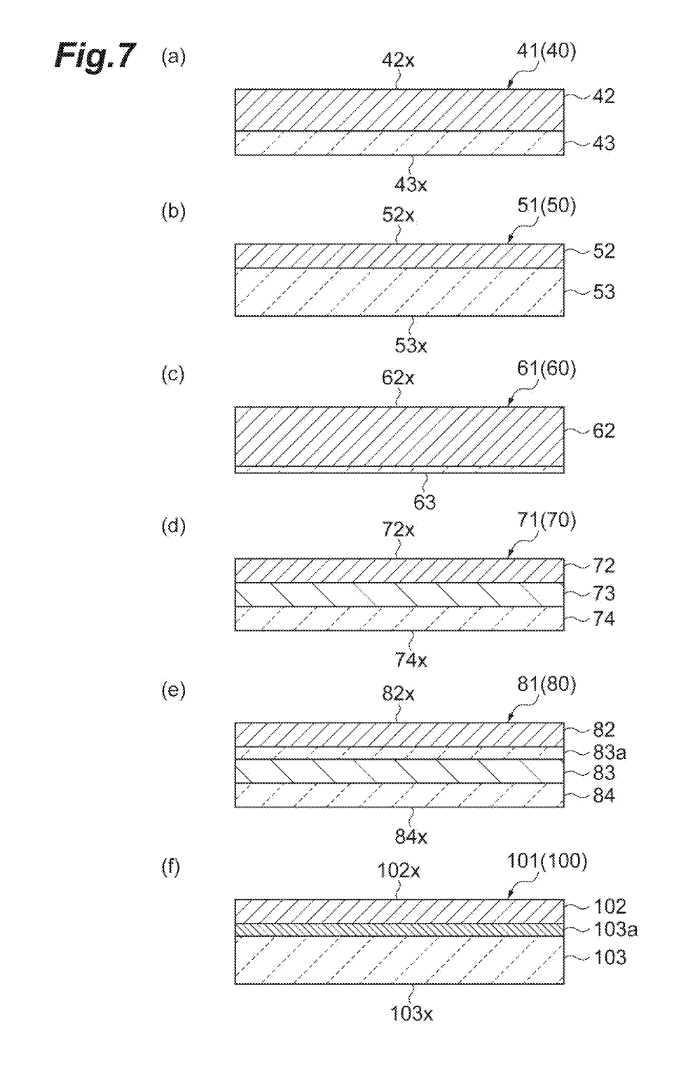

Further, a case in which the shield plate 20 has a three-layer structure in which the substrate layer 23, the blackbody layer 24, and the reflective layer 22 are stacked, and the substrate layer 23 is, for example, copper member (a copper plate or a copper layer) has been described, but the present invention is not limited thereto. That is, as in a shield plate 80 illustrated in FIG. 7(e), a base 81 may include a substrate layer 83, a blackbody layer (a first layer) 84 having a blackbody surface (a first surface) 84x as an outer surface, a heat insulating material (heat insulating layer) 83a provided such that the substrate layer 83 is sandwiched between the heat insulating material 83a and the blackbody layer 84, and a reflective layer (a second layer) 82 provided so that the heat insulating material 83a is sandwiched between the reflective layer 82 and the substrate layer 83 and having a reflective surface (a second surface) 82x as an outer surface. By providing the heat insulating material 83a between the substrate layer 83 and the reflective layer 82, the amount of heat conduction of the substrate layer 83 to the reflective layer 82 can be smaller than the amount of heat conduction from the substrate layer 83 to the blackbody layer 84. Accordingly, the amount of thermal radiation of the blackbody surface can be larger than the amount of thermal radiation of the reflective surface. A fiber-based heat insulating material or a foam-based heat insulating material can be used as the heat insulating material 83a. Further, a heat insulating layer may be formed by providing a vacuum layer between the substrate layer 83 and the reflective layer 82 in place of the heat insulating material 83a.

Further, for example, as illustrated in FIGS. 7(a) and 7(b), the base of the shield plate may have a two-layer structure. The base 41 of the shield plate 40 in FIG. 7(a) includes a substrate layer 42 having a reflective surface (a second surface) 42x as an outer surface, and a blackbody layer (a first layer) 43 having a blackbody surface (a first surface) 43x as an outer surface, which is provided to overlap the substrate layer 42. The amount of thermal radiation of the blackbody layer 43 is larger than the amount of thermal radiation of the substrate layer 42. Accordingly, the amount of thermal radiation of the blackbody surface 43x and the amount of thermal radiation of the reflective surface 42x can be easily caused to be different from each other. Further, by the base 41 having a two-layer structure, it is easy to manufacture the shield plate. Copper (a copper plate or a copper layer) or gold (a gold plate or a gold layer) can be used as the substrate layer 42. A ceramic coating of the blackbody, for example, can be used as the blackbody layer 43.

A base 51 of a shield plate 50 in FIG. 7(b) includes a substrate layer 53 having a blackbody surface (a first surface) 53x as an outer surface, and a reflective layer 52 having a reflective surface (a second surface) 52x as an outer surface, which is provided to overlap the substrate layer 53. The amount of thermal radiation of the reflective layer 52 is smaller than the amount of thermal radiation of the substrate layer 53. Accordingly, the amount of thermal radiation of the blackbody surface 53x and the amount of thermal radiation of the reflective surface 52x can be easily caused to be different from each other. Further, due to the base 51 having a two-layer structure, it is easy to manufacture the shield plate. Carbon or graphene, for example, can be used for the substrate layer 53. Further, a gold plating, for example, may be used as the reflective layer 52.

Further, the case in which the shield plate 50 has a two-layer structure in which the substrate layer 53 and the reflective layer 52 are stacked has been described, but the present invention is not limited thereto. That is, as in a shield plate 100 illustrated in FIG. 7(f), a base 101 may include a substrate layer 103 having a blackbody surface (a first surface) 103x as an outer surface, and a heat insulating material (a heat insulating layer) 103a provided to be sandwiched between a reflective layer 102 having a reflective surface (a second surface) 102x as an outer surface and the substrate layer 103. By providing the heat insulating material 103a between the substrate layer 103 and the reflective layer 102, the amount of heat conduction from the substrate layer 103 to the reflective layer 102 can be smaller than the amount of heat conduction of the substrate layer 103. Accordingly, it is possible to easily cause the amount of thermal radiation of the blackbody surface to be larger than the amount of thermal radiation of the reflective surface. A fiber-based heat insulating material or a foam-based heat insulating material may be used as the heat insulating material 103a. Further, the heat insulating layer may be formed by providing a vacuum layer between the substrate layer 103 and the reflective layer 102 in place of the heat insulating material 103a.

Further, the shield plate may include only a substrate layer, as illustrated in FIG. 7(c). A base 61 of the shield plate 60 in FIG. 7(c) includes a substrate layer 62 having a reflective surface (a second surface) 62x as an outer surface. In the substrate layer 62, a surface opposite to the reflective surface 62x becomes a blackbody surface 63 (a first surface) due to a blackening treatment. Thus, by forming the blackbody surface by processing the substrate layer having the reflective surface, it is easier for the shield plate to be manufactured, and it is possible to reduce the number of components. Gold (such as a gold plate), for example, can be used as the substrate layer 62. In this case, the blackbody surface 63 subjected to the blackening treatment is blackened gold.

Further, as illustrated in FIG. 7(d), a base 71 of a shield plate 70 has a three-layer structure, and a substrate layer 73 having a thermoelectric element, a blackbody layer (a first layer) 74 having a blackbody surface (a first surface) 74x as an outer surface, and a reflective layer (a second layer) 72 having a reflective surface (a second surface) 72x as an outer surface may be stacked. The thermoelectric element is, for example a Peltier element, a Seebeck element, or a Thomson element. A black ceramic coating, for example, can be used as the blackbody layer 74. A gold plating, for example, may be used as the reflective layer 72. For example, when a Peltier element is used as the thermoelectric element, the substrate layer 73 absorbs heat at a junction between the substrate layer 73 and the reflective layer 72 that is gold plating and generates heat at a junction between the substrate layer 73 and the blackbody layer 74 that is a black ceramic coating when a current or a voltage is applied. Thus, the amount of thermal radiation of the blackbody surface of the blackbody layer 74 is larger than the amount of thermal radiation of the reflective surface of the reflective layer 72. When the substrate layer 73 having the thermoelectric element is used, a temperature controller (a temperature control unit) is electrically coupled to the thermoelectric element and applies a current or voltage to control the temperature of the shield plate 70. Accordingly, the temperature of the shield plate having the thermoelectric element can be easily and reliably controlled.

Further, the case in which the central shield portion 21z is in a blackbody state has been described, but the present invention is not limited thereto, at least the opposite shield portion (a second shield portion) formed to face the opening in the blackbody surface may be in a blackbody state with respect to infrared rays, and the central shield portion may not necessarily be in a blackbody state.

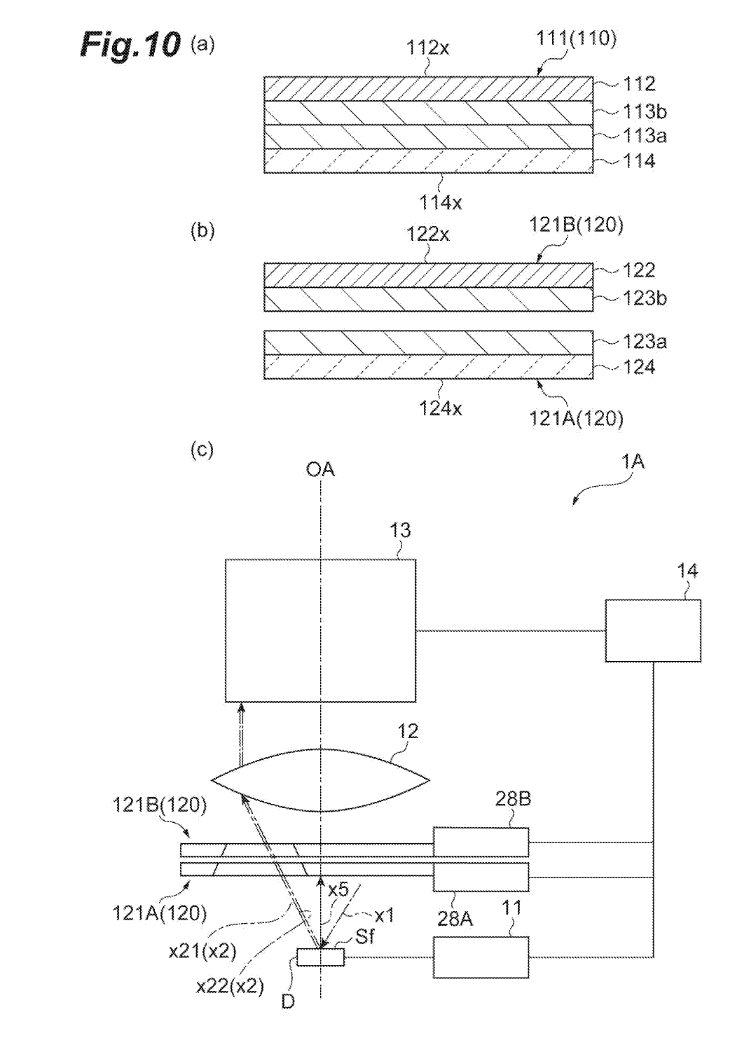

Further, as in the shield plate 110 illustrated in FIG. 10(a), a base 111 in the shield plate may include a first substrate layer (a substrate layer) 113a of which temperature is adjustable, a blackbody layer (a first layer) 114 having a blackbody surface (a first surface) 114x as an outer surface, a second substrate layer 113b that is provided so that the first substrate layer 113a is sandwiched between the second substrate layer 113b and the blackbody layer 114 and of which temperature is adjustable, and a reflective layer (a second layer) 112 that is provided so that the second substrate layer (a substrate layer) 113b is sandwiched between the reflective layer 112 and the first substrate layer 113a and has a reflective surface (a second surface) 112x as an outer surface. By providing the second substrate layer 113b thermally coupled to the reflective layer 112 between the first substrate layer 113a and the reflective layer 112, it is possible to adjust temperature of the reflective layer 112 to be constant and improve SN. If it is possible to adjust the temperature of the reflective layer 112 to be constant, it is possible to prevent a dark level of the infrared camera 13 from changing. Thus, it is not necessary for the reflective layer 112 necessarily to have a reflective surface that is a mirror surface due to high reflectance of the outer surface. Further, for the first substrate layer 113a and the second substrate layer 113b, for example, a member such as copper member (a copper plate or a copper layer) having high thermal conductivity capable of realizing uniform temperature may be used, and the temperature may be adjusted to be constant by the temperature controller (a temperature control unit) coupled to the member. Further, for example, a thermoelectric element may be used as a temperature adjustment layer, and the temperature may be adjusted to be constant by a temperature controller coupled to the element. Further, the first substrate layer 113a and the second substrate layer 113b may not be thermally coupled to each other and, for example, a heat insulating material or a vacuum layer may be provided between the first substrate layer 113a and the second substrate layer 113b to reduce the amount of heat conduction.

Further, as in a shield plate 120 illustrated in FIG. 10(b), the shield plate 120 may include a first substrate layer (a substrate layer) 123a, a first base 121A including a blackbody layer (a first layer) 124 having a blackbody surface (a first surface) 124x as an outer surface, a second substrate layer (a substrate layer) 123b, and a second base 121B including a reflective layer (a second layer) 122 having a reflective surface (a second surface) 122x as an outer surface. In the shield plate 120, the first substrate layer 123a is physically in contact with the second substrate layer 123b, and heat conduction between the first substrate layer 123a and the second substrate layer 123b is reduced, unlike in the shield plate 110. Further, since the shield plate 120 includes the two bases as described above, the base 121A is arranged to be coupled to the temperature controller 28A, the base 121B is arranged to be coupled to the temperature controller 28B, and the bases are used for temperature measurement of the semiconductor apparatus D, as in the measurement apparatus 1A illustrated in FIG. 10(c). Since the two bases (121A and 121B) can be subjected to temperature control by the different temperature controllers, it is possible to maintain a constant temperature in the second substrate layer 123b and maintain radiation of a constant amount of thermal radiation from the base 121B to the infrared camera 13, for example, while changing the amount of thermal radiation radiated from the base 121A to the semiconductor apparatus D by changing the temperature of the first substrate layer 123a.

### Second Embodiment

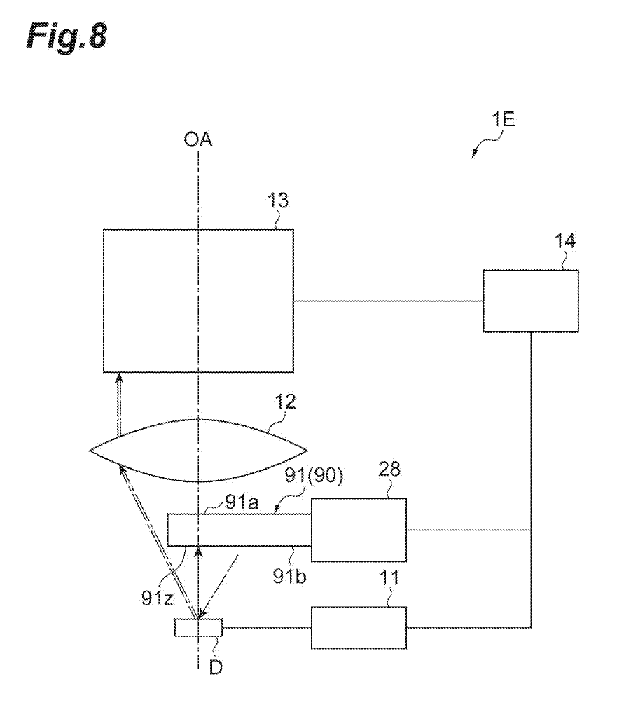

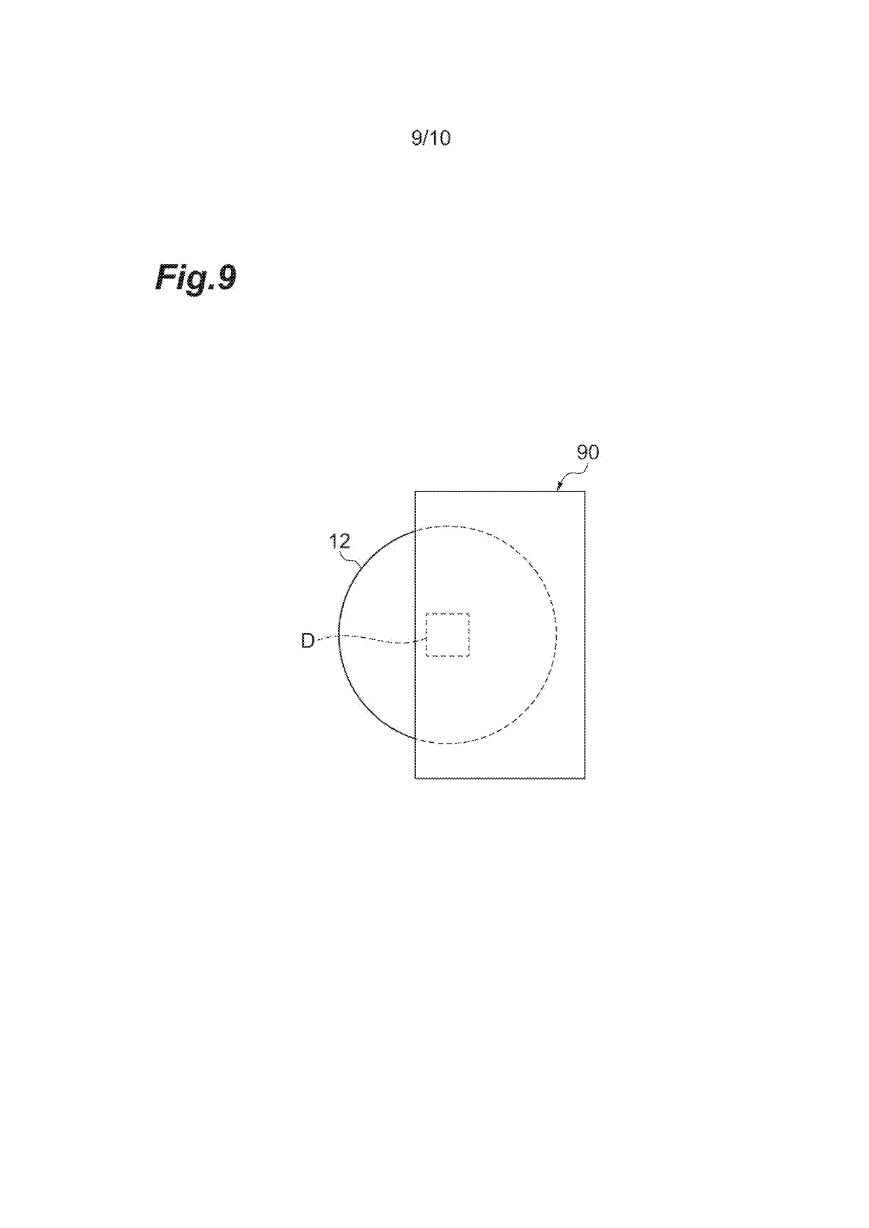

Next, a shield plate 90 and a measurement apparatus 1E including the shield plate 90 according to a second embodiment will be described with reference to FIGS. 8 and 9. In description of this embodiment, differences from the first embodiment described above will be mainly described.

As illustrated in FIG. 8, the measurement apparatus 1E has the same configuration as the measurement apparatus 1 described above except for the shield plate 90. The base 91 of the shield plate 90 has a blackbody surface 91b having a larger amount of thermal radiation as one surface and a reflective surface 91a having a smaller amount of thermal radiation than the blackbody surface 91b as the other surface. The shield plate 90 is arranged between the semiconductor apparatus D and the infrared camera 13. The shield plate 90 has an optical axis shield portion 91z having a blackbody surface that is in a blackbody state, which shields heat rays including only heat rays emitted from the semiconductor apparatus D in a state in which the shield plate 90 is arranged between the semiconductor apparatus D and the infrared camera 13.

Here, the shield plate 90 arranged between the semiconductor apparatus D and the infrared camera 13 does not include the opening 21c, unlike the shield plate 20 of the measurement apparatus 1 described above. Further, in the shield plate 90, a region biased to one side relative to the optical axis OA is located directly above the semiconductor apparatus D, as illustrated in FIG. 9.

Thus, by arranging the shield plate 90 including no openings 21c so that the region biased to one side relative to the optical axis OA is located directly above the semiconductor apparatus D, it is possible to obtain a configuration in which the shield plate 90 does not shield a portion of a path of the heat rays from the semiconductor apparatus D to the objective lens 12. That is, by arranging the shield plate 90 to be shifted from the optical axis OA, it is possible to obtain the same effects as in formation of the opening 21c in the shield plate 20 of the first embodiment. Accordingly, it is possible to cause the heat rays in which the heat rays generated by the semiconductor apparatus D and the heat rays reflected by the semiconductor apparatus D are superimposed, to reach the infrared camera 13 via the objective lens 12.

### REFERENCE SIGNS LIST

1, 1E Measurement apparatus
11 Tester unit (signal input unit)
12 Objective lens (light guiding optical system)
13 Infrared camera (imaging unit, infrared detector)
14 Computer (calculation unit),
20, 20A, 20B, 20D, 40, 50, 60, 70, 80, 90 Shield plate
21, 21A, 21B, 21D, 41, 51, 61, 71, 81, 91 Substrate
21c, 21Ac, 21Bc, 21Dc Opening
21e, 21Ae, 21Be, 31D Opposite shield portion
21a, 42x, 52x, 62x, 91a Reflective surface (second surface)
21b, 43x, 53x, 63, 91b Blackbody surface (first surface)
21z Central shield portion
22, 52, 72, 82 Reflective layer (second layer)
23, 42, 53, 62, 73, 83 Substrate layer
24, 43, 74, 84 Blackbody layer (first layer)
28 Temperature controller (temperature control unit)
31, 31A, 31B Peripheral shield portion
83a Heat insulating material (heat insulating layer)
CA Central axis
D Semiconductor apparatus (measurement target)
OA Optical axis

1. A shield plate used for non-contact measurement of temperature of a measurement target, the shield plate comprising:
a base of which temperature is adjustable,
wherein the amount of thermal radiation of a first surface located on one side of the base is larger than the amount of thermal radiation of a second surface located on a side opposite to the first surface, and
the first surface is a blackbody surface configured to emit infrared rays.

2. The shield plate according to claim 1,
wherein the base comprises a substrate layer, a first layer having the first surface as an outer surface, and a second layer having the second surface as an outer surface, the second layer being provided so that the substrate layer is sandwiched between the second layer and the first layer, and
the amount of thermal radiation of the first layer is larger than the amount of thermal radiation of the second layer.

3. The shield plate according to claim 1,
wherein the base comprises a substrate layer having the second surface as an outer surface, and a first layer having the first surface as an outer surface, the first layer being provided to be overlap the substrate layer, and
the amount of thermal radiation of the first layer is larger than the amount of thermal radiation of the substrate layer.

4. The shield plate according to claim 1,
wherein the base comprises a substrate layer having the first surface as an outer surface, and a second layer having the second surface as an outer surface, the second layer being provided to be overlap the substrate layer, and
the amount of thermal radiation of the second layer is smaller than the amount of thermal radiation of the substrate layer.

5. The shield plate according to claim 1,
wherein the first surface is formed by a blackening treatment.

6. The shield plate according to claim 1,
wherein the base comprises
a substrate layer,
a second layer having the second surface as an outer surface, and
a heat insulating layer provided between the substrate layer and the second layer and preventing heat from being conducted from the substrate layer to the second layer.

7. The shield plate according to claim 1,
wherein the second surface is a reflective surface configured to reflect infrared rays.

8. The shield plate according to claim 1,
wherein emissivity of the first surface is higher than emissivity of the second surface.

9. A measurement apparatus for performing non-contact measurement of temperature of a measurement target, the measurement apparatus comprising:
an optical system configured to guide infrared rays from the measurement target;
an imager optically coupled to the optical system, configured to image the infrared rays from the measurement target, and output thermal image data;
the shield plate according to claim 1 arranged between the measurement target and the optical system; and
a temperature controller configured to control temperature of the base of the shield plate.

10. The measurement apparatus according to claim 9, further comprising:
a calculator configured to calculate the temperature of the measurement target based on the thermal image data.

11. The measurement apparatus according to claim 10,
wherein the temperature controller controls the temperature of the base of the shield plate such that the temperature is controlled to be at least a first temperature and a second temperature different from the first temperature, and
the calculator calculates the temperature of the measurement target based on the thermal image data at the first temperature and the thermal image data at the second temperature.

12. The measurement apparatus according to claim 10,
wherein the imager comprises an infrared detector.
